(19) United States
(12) Patent Application Publication
(10) Pub. No.: US 2015/0260827 A1
(43) Pub. Date: Sep. 17, 2015

(54) Radome-free microwave sensor, method for installing a radome-free microwave sensor in a vehicle and combination of a vehicle component with a radome-free microwave sensor

(71) Applicant: Robert Bosch GmbH, Stuttgart (DE)

(72) Inventors: Maik Hansen, Leonberg (DE); Armin Himmelstoss, Weissach Im Tal (DE)

(21) Appl. No.: 14/632,055

(22) Filed: Feb. 26, 2015

(30) Foreign Application Priority Data
Mar. 11, 2014 (DE) 10 2014 204 385.9

(51) Int. Cl. G01S 7/02; H01Q 1/32; B60R 19/48; B60R 1/02; B60J 1/20; B60R 1/00; H01Q 1/42; G01S 13/02

(52) U.S. Cl. CPC G01S 7/02; H01Q 1/42; H01Q 1/3283; H01Q 1/3266; G01S 13/02; B60R 1/02; B60J 1/20; B60R 1/006; B60R 19/483; G01S 2007/027

(57) ABSTRACT

A radome-free microwave sensor includes: a microwave antenna, with the aid of which microwaves are emitted and received; and a sealing device, with the aid of which a cavity enclosing the microwave antenna is closed when the sealing device abuts against a component of the vehicle.

### BACKGROUND OF THE INVENTION

1. Field of the Invention

The present invention relates to a radome-free microwave sensor for installation in a vehicle, a method for installing a radome-free microwave sensor in a vehicle, and a combination of a vehicle component with a radome-free microwave sensor.

2. Description of the Related Art

Radar sensors for the automobile industry are often manufactured and delivered sealed against influences from the environment. Such radar sensors often function as so-called microwave sensors based on microwave radiation. Microwave radiation is initially sent out from the microwave sensors. Microwaves reflected off external objects are received by the microwave sensors and analyzed by evaluation circuits. Special microwave-safe plastics are used in the area of a microwave radiation input/output surface. These elements are referred to as “radomes.” A radome may be designed in such a way that it does not affect the beam path of the microwaves. Radomes may also be designed in such a way that the beam path of the microwaves is selectively affected, in which case the radome is also referred to as a “lens.” Faceplates in front after assembly, which are primarily preferred for their visual appearance, are also frequently referred to as radomes.

Ultrasound-based parking sensor systems are usually visibly mounted in recesses in a bumper or in the vehicle body. Parking sensor systems based on electromagnetic wave propagation, using radar sensors, do not require the usual openings in the bumper or the vehicle body. Radar sensors having a radome or lens are conventionally installed hidden, i.e., behind the bumper or the vehicle body. In this case, radar sensors having a radome or lens are supplied as a one-piece part and then installed in the vehicle, as described above.

Undesirable reflections of microwaves, such as those already in the transmission signal path of the microwaves, occur in particular due to insufficient insertion attenuation of the materials for the microwaves. Microwave radiation reflected directly in front of the microwave sensors may disrupt the reception. The measuring dynamic of the microwave sensor may be degraded by such interference signals.

Published German utility model document DE 201 18 265 U1 describes a device for the assembly and attachment of parking sensors in bumper systems. The accommodation for the parking sensor is made up of an essentially cylindrical bracket and at least two elastic fastening elements integrated therein, each having two detent recesses. The detent recesses correspond to parking sensor detent elements.

### BRIEF SUMMARY OF THE INVENTION

The present invention provides a radome-free microwave sensor for the installation in a vehicle, including: a microwave antenna, with the aid of which microwaves may be emitted and received; and a sealing device, with the aid of which a closed cavity may be formed when the sealing device abuts against a component of the vehicle; the cavity enclosing the microwave antenna.

Furthermore, a method is provided for installing a radome-free microwave sensor in a vehicle, in particular a radome-free microwave sensor according to the present invention, including the steps: applying a sealing device of the microwave sensor to a component of the vehicle in such a way that a closed cavity is formed; and also in such a way that the cavity encloses a microwave antenna of the microwave sensor.

Furthermore, a combination is provided for a vehicle component with a radome-free microwave sensor, in particular with a radome-free microwave sensor according to the present invention, where a sealing device of the microwave sensor abuts against the vehicle component in such a way that a closed cavity is formed; the cavity enclosing a microwave antenna of the microwave sensor, with the aid of which microwaves may be emitted and received.

Here, the microwave antenna of the microwave sensor may include one or multiple individual antennas, which are coupled to each other via a circuit, e.g., via a phase shifting circuit, and are controllable individually and/or together. The microwave antenna may have multiple sections, of which one is designed for emitting microwaves and another for receiving microwaves; however, individual antennas or all microwave antennas together may also be designed for both emitting and receiving microwaves.

An enclosure of the microwave antennas by the closed cavity means that the microwave antenna is situated within the closed cavity. In particular, the microwave antenna may be situated on the inner surface of the closed cavity.

The finding underlying the present invention is that, in order to avoid unnecessary defects in the transmission signal path of the microwaves, vehicle parts, i.e., a component of the vehicle, also known as a vehicle component, is usable as part of a radome-like seal for microwave sensors against environmental influences.

The idea underlying the present invention is now to take this finding into account and provide a radome-free microwave sensor including a sealing device, the sealing device being usable in such a way that a cavity is formed from parts of the sealing device, the microwave sensor and the vehicle component, by applying the sealing device to a vehicle component, which provides a seal for the microwave sensor in the form of a radome.

According to the present invention, a potential number of defects is reduced for the microwave sensor, whereby the emission and reception characteristics of the microwave sensor may be improved. By reducing the number of defects, the number of reflected microwaves occurring on or in the vehicle is essentially reduced, thereby making it possible to reduce interferences and, for example, the number of destructive overlaps of wave fronts. This may result in less desensitization of the microwave sensor. In particular, measurements by the radar sensor in close range of the radar sensor may be improved in this way.

Another advantage is that the vehicle component to which the radome-free microwave sensor is applied may be manufactured with less technical effort, since, for example, no pre-fabricated recesses, brackets, detent elements or the like need to be designed. Furthermore, installation problems may be avoided with respect to a degradation of antenna radiation patterns by defects. For example, smaller installation tolerances may be taken into account. The component of the vehicle to which the microwave sensor is to be applied may be measured and taken into account in an overall antenna diagram for the microwave sensor.

According to one preferred refinement, the sealing device is constructed in such a way that the closed cavity may be formed as a component of the vehicle when the sealing device abuts against a bumper, a vehicle body part, a window, a lens, rear-view mirror and/or a side mirror. In this way, the radome-free microwave sensor may be used for a variety of different components for various vehicles, whereby the microwave sensor according to the present invention is more versatile. By using the radome-free microwave sensor according to the present invention, the design freedom for vehicle designers is also extended, since certain components, such as a bumper, no longer need to be specially adapted to conform to radome-protected microwave sensors.

According to one further preferred refinement, the sealing device is constructed in such a way that the closed cavity may be formed when the sealing device abuts against a component, which is made of plastic or glass. As a result, the usability of the microwave sensor according to the present invention may be further increased and the design freedom for vehicle designers is further extended.

According to one further preferred refinement, the sealing device is constructed in such a way that the closed cavity may be formed when the sealing device abuts against a vehicle component, which functions as a lens for microwaves which may be emitted and/or received. This may result in a further improvement of the usability of the microwave sensor according to the present invention.

According to one preferred refinement of the method according to the present invention, the vehicle component to which the sealing device of the microwave sensor is applied is a bumper, a vehicle body part, a window, a lens, a rear-view mirror or a side mirror.

According to one further preferred refinement of the method according to the present invention, the vehicle component to which the sealing device of the microwave sensor is applied is made of plastic or glass, or includes plastic and/or glass.

According to one further preferred refinement of the method according to the present invention, the vehicle component to which the sealing device of the microwave sensor is applied functions as a lens for the emitted and/or received microwaves.

According to one further preferred refinement of the combination, according to the present invention, of a vehicle component with a radome-free microwave sensor, the vehicle component is a bumper, a vehicle body part, a window, a lens, a rear-view mirror or a side mirror.

### BRIEF DESCRIPTION OF THE DRAWINGS

FIG. 1 shows a schematic view of a microwave sensor according to the present invention according to a first specific embodiment of the present invention and a combination, according to the present invention, of a component of a vehicle with a radome-free microwave sensor according to a second specific embodiment of the present invention.

FIG. 2 shows a schematic flow chart for explaining a method for installing a radome-free microwave sensor 10 in a vehicle F, according to a third specific embodiment of the present invention.

### DETAILED DESCRIPTION OF THE INVENTION

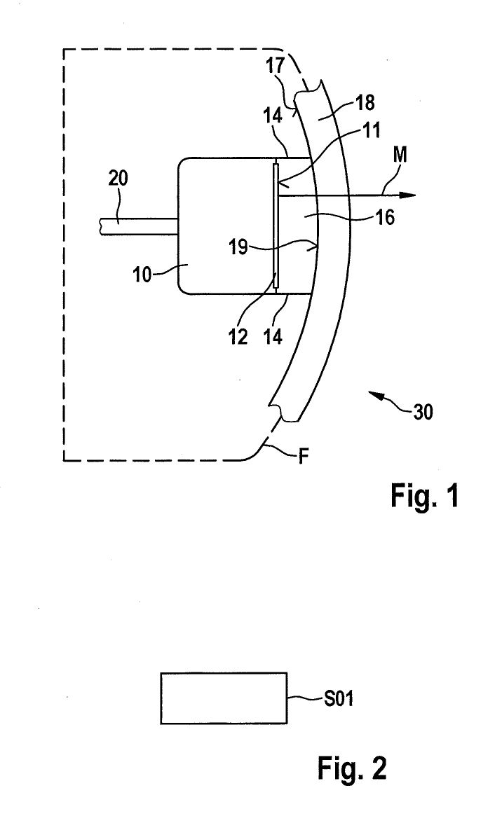

FIG. 1 shows a schematic view of a microwave sensor 10 according to a first specific embodiment of the present invention, as well as a combination 30 of a component of a vehicle with a radome-free microwave sensor according to a second specific embodiment of the present invention.

In FIG. 1, radome-free microwave sensor 10 is attached to a bumper 18 with a sealing device 14. Bumper 18 is a component of a vehicle F. A microwave antenna 12, which as an example may be made up of a plurality of individual antennas, is situated on an outer surface 11 of microwave sensor 10. The proportions in FIG. 1 are not true to scale. In particular, for the sake of improved clarity, bumper 18 is shown in FIG. 1 significantly scaled down in comparison to the remaining elements.

Microwave antenna 12 is designed for emitting and receiving microwaves M. Typical wavelengths of microwaves may be between 300 mm and 1 mm; typical frequency ranges of microwaves may be between 300 MHz and 300 GHz.

According to the present specific embodiment, microwave antenna 12 is fully enclosed on outer surface 11 of microwave sensor 10 by sealing device 14. Due to the fact that sealing device 14 abuts against a surface 17 of bumper 18 which faces inward in relation to vehicle F, a closed cavity 16 results. According to the present specific embodiment, the wall surfaces of closed cavity 16 are formed by outer surface 11 of the microwave sensor, by sealing device 14 and by a section 19 of surface 17 of bumper 18. Cavity 16 acts as a radome cavity for microwave sensor 10 and in particular seals microwave sensor 10 against environmental influences. The seal may be a hermetic seal. Microwave sensor 10 is connectable to an electrical power source, in particular a power source of vehicle F, via a power cable 20, of microwave sensor 10 in order to supply power to microwave sensor 10.

FIG. 2 shows a schematic flow chart to explain a method for installing radome-free microwave sensor 10 in a vehicle F, according to a third specific embodiment of the present invention.

In a method step S01, sealing device 14 is attached to component 18 of vehicle F, in such a way that cavity 16 is formed. Furthermore, the sealing device is applied in such a way that closed cavity 16 encloses microwave antenna 12 of microwave sensor 10.

Although the present invention has been described with reference to the preferred exemplary embodiments, it is not limited thereto and is modifiable in a variety of ways. In particular, the present invention may be altered or modified in many ways without departing from the core of the present invention.

The method according to the present invention is, for example, analogous to the different variants and refinements of the microwave sensor according to the present invention, as they are described above and below, and are readily adaptable by those skilled in the art.

The radome-free microwave sensor may be manufactured and/or installed together with the vehicle component to which it is to be applied, so as to reduce the technical complexity during the manufacture of the vehicle.

What is claimed is:

1. A radome-free microwave sensor for installation in a vehicle, comprising:
a microwave antenna configured to emit and receive microwaves; and
a sealing device, with the aid of which a cavity enclosing the microwave antenna is closed when the sealing device abuts against a component of the vehicle.

2. The microwave sensor as recited in claim 1, wherein the sealing device is configured to close the cavity when the sealing device abuts against at least one of a bumper, a vehicle body part, a window, a lens, a rear-view mirror, and a side mirror of the vehicle.

3. The microwave sensor as recited in claim 1, wherein the sealing device is configured to close the cavity when the sealing device abuts against a component which includes at least one of plastic and glass.

4. The microwave sensor as recited in claim 1, wherein the sealing device is configured to close the cavity when the sealing device abuts against a component of the vehicle which functions as a lens for microwaves which are at least one of emitted and received.

5. A method for installing a radome-free microwave sensor in a vehicle, comprising:
providing a sealing device which encloses a microwave antenna of the microwave sensor; and
applying the sealing device to a component of the vehicle in such a way that a closed cavity is formed by abutment of the sealing device and the component of the vehicle.

6. The method as recited in claim 5, wherein the component of the vehicle is one of a bumper, a vehicle body part, a window, a lens, a rear-view mirror or a side mirror.

7. The method as recited in claim 5, wherein the component of the vehicle includes at least one of plastic and glass.

8. The method as recited in claim 5, wherein the component of the vehicle functions as a lens for microwaves which are at least one of emitted and received.

9. A sensor system of a vehicle, comprising:
a component of the vehicle; and
a radome-free microwave sensor having (i) a microwave antenna configured to emit and receive microwaves, and (ii) a sealing device, with the aid of which a cavity enclosing the microwave antenna is closed when the sealing device abuts against the component of the vehicle.

10. The combination as recited in claim 9, wherein the component of the vehicle is one of a bumper, a vehicle body part, a window, a lens, a rear-view mirror or a side mirror.
